(19) United States
(12) Patent Application Publication
(10) Pub. No.: US 2026/0249880 A1
(43) Pub. Date: Aug. 27, 2026

(54) VEHICLE AND METHOD OF CONTROLLING THE SAME

(71) Applicants: HYUNDAI MOTOR COMPANY, Seoul (KR); KIA CORPORATION, Seoul (KR)

(72) Inventor: Byoung Kwang KIM, Hwaseong-si (KR)

(21) Appl. No.: 19/455,054

(22) Filed: Jan. 21, 2026

(30) Foreign Application Priority Data
Feb. 27, 2025 (KR) 10-2025-0025987

(51) Int. Cl. B60W 60/00; G01C 21/36

(52) U.S. Cl. CPC B60W 60/0011; G01C 21/3658; B60W 2552/30; B60W 2552/53

(57) ABSTRACT

Disclosed herein a vehicle and a method of controlling the same. When the vehicle enters a junction on a navigation map, the vehicle selects a nearby route from a plurality of nearby routes as a final traveling route to be guided by a navigation system based on a curvature radius of each of the plurality of nearby routes split at the junction and a curvature radius of a current lane on which the vehicle is traveling.

### CROSS-REFERENCE TO RELATED APPLICATION

This application claims the benefit of priority Korean Patent Application No. 10-2025-0025987, filed in the Korean Intellectual Property Office on Feb. 27, 2025, the disclosure of which is incorporated herein by reference in its entirety.

### TECHNICAL FIELD

The present disclosure relates to a vehicle and a method of controlling the same, and more specifically, to a vehicle capable of correcting a route at a junction using lane line information and a method of controlling the same.

### BACKGROUND

The matters described in this Background section are only for enhancement of understanding of the background of the disclosure, and should not be taken as acknowledgment that they correspond to prior art already known to those skilled in the art.

Autonomous driving is a technology that enables a vehicle to recognize its surroundings, determine a traveling route to move using technologies of sensors, cameras, artificial intelligence, and the like without human intervention or with some human intervention. The autonomous driving may be classified into five levels, in which Level 0 refers to complete manual driving and Level 5 refers to complete autonomous driving.

Level 2 autonomous driving is autonomous driving to which some automation is applied and in which a vehicle may automatically perform major functions such as acceleration, braking, and steering, but a driver may always monitor a driving situation and intervene immediately if necessary.

For example, in Level 2 or 2.5 autonomous driving, a vehicle may use a cruise control function that automatically adjusts a speed using navigation map data or adjusts the speed or supports a lane keeping function based on a navigation system on a highway.

In this arrangement, a semi-autonomous vehicle may control its driving speed based on the speed limit associated with the route guided by the navigation system. In addition, even when the navigation system guides the vehicle to travel along a branch route rather than a main line at a junction, the vehicle may continue traveling straight along the main line if the driver does not manually steer. In this case, when the speed limit of the main line differs from the speed limit of the branch route, the navigation system may continue guiding the branch route, causing the vehicle to follow the speed limit of the branch route even while traveling on the main line. As a result, the vehicle travels at a speed significantly lower than the speed limit of the main line, which may disrupt a traffic flow.

In addition, when route correction is attempted using a positional difference between global positioning system (GPS) coordinates of the vehicle and the branch route guided by the navigation system, the position difference has to reach a predetermined value. As a result, when attempting to correct the route guided by the navigation using the GPS coordinates, the vehicle may remain on the main line for a considerable time while still operating at the speed limit of the branch route rather than the higher speed limit of the main line.

### SUMMARY

The various examples of the present disclosure are directed to providing a vehicle and a method of controlling the same that may detect, at an early stage, instances where the vehicle does not follow a navigation-guided route at a junction during ADAS-based autonomous driving without a high-definition map, and thereby correct the navigation route more quickly than the conventional GPS-based method.

Technical examples to be achieved by the present disclosure are not limited to that described above, and other technical objects that have not been described will be clearly understood by those skilled in the technical field to which the present disclosure pertains from the following description.

According to the present disclosure, a vehicle may comprise a navigation system configured to provide a navigation map, a processor, and a memory storing at least one instruction that, when executed by the processor, is configured to cause the vehicle to determine that the vehicle has entered a junction indicated on the navigation map, select, based on the determination, a final traveling route from among a plurality of routes that split at the junction, wherein the final traveling route is selected based on neighboring curvature radii respectively corresponding to the plurality of routes and a current curvature radius corresponding to a current lane on which the vehicle is traveling, output a signal indicating the final traveling route, and control, based on the signal, autonomous driving of the vehicle.

The at least one instruction, when executed by the processor, is configured to cause the vehicle to, based on the determination that the vehicle has entered the junction, switch to a route correction mode, determine the neighboring curvature radii respectively corresponding to the plurality of routes and determine the current curvature radius corresponding to the current lane, determine, based on the neighboring curvature radii and the current curvature radius, a reliability associated with each of the plurality of routes, and select, as the final traveling route, whichever route among the plurality of routes is associated with a highest reliability for guidance by the navigation system. The at least one instruction, when executed by the processor, is configured to cause the vehicle to detect a lane line of the current lane, generate, based on the lane line, lane line information, determine, based on the navigation map, the neighboring curvature radii, and determine, based on the lane line information, the current curvature radius.

The at least one instruction, when executed by the processor, is configured to cause the vehicle to determine a curvature radius difference between each of the neighboring curvature radii and the current curvature radius, determine a shortest distance between each of the plurality of routes and a current position of the vehicle, and, based on the curvature radius difference and the shortest distance, determine the reliability associated with each of the plurality of routes. The at least one instruction, when executed by the processor, is configured to cause the vehicle to, based on at least one of the shortest distances being equal to or greater than a preset threshold distance, end the route correction mode.

According to the present disclosure, a vehicle may comprise a navigation system configured to provide a navigation map, a processor, and a memory storing at least one instruction that, when executed by the processor, is configured to cause the vehicle to determine that the vehicle has entered a junction indicated on the navigation map, select, based on the determination, a final traveling route from among a plurality of routes that split at the junction, wherein the final traveling route is selected based on a shape of each of the plurality of routes and a shape of a current lane on which the vehicle is traveling, output a signal indicating the final traveling route, and control, based on the signal, autonomous driving of the vehicle.

The at least one instruction, when executed by the processor, is configured to cause the vehicle to, based on the determination that the vehicle has entered the junction, switch to a route correction mode, determine neighboring regression polynomials representing respective shapes of the plurality of routes, determine a current regression polynomial representing a shape of the current lane, determine, based on the neighboring regression polynomials and the current regression polynomial, a reliability associated with each of the plurality of routes, and select, as the final traveling route, whichever route among the plurality of routes is associated with a highest reliability for guidance by the navigation system. The at least one instruction, when executed by the processor, is configured to cause the vehicle to detect a lane line of the current lane, generate, based on the lane line, lane line information, determine, based on the navigation map, the neighboring regression polynomials, and determine, based on the lane line information, the current regression polynomial.

The at least one instruction, when executed by the processor, is configured to cause the vehicle to determine, for each of the plurality of routes, a difference between a neighboring regression polynomial representing the corresponding route and the current regression polynomial, and determine, based on the difference, a reliability associated with each of the plurality of routes. The at least one instruction, when executed by the processor, is configured to cause the vehicle to determine a shortest distance between each of the plurality of routes and a current position of the vehicle, and, based on at least one of the shortest distances being equal to or greater than a preset threshold distance, end the route correction mode.

According to the present disclosure, a vehicle may comprise a navigation system configured to provide a navigation map, wherein first geometric information representing a plurality of routes that split at a junction is obtained from the navigation map, a sensor configured to detect lane lines of a current lane on which the vehicle is traveling and to provide second geometric information representing the current lane, a processor, and a memory storing at least one instruction that, when executed by the processor, is configured to cause the vehicle to determine that the vehicle has entered a junction indicated on the navigation map, based on the determination, the first geometric information, and the second geometric information, select a final traveling route from among the plurality of routes, output a signal indicating the final traveling route, and control, based on the signal, autonomous driving of the vehicle.

The final traveling route is selected based on neighboring curvature radii respectively corresponding to the plurality of routes and a current curvature radius corresponding to the current lane. The at least one instruction, when executed by the processor, is configured to cause the vehicle to determine, based on the neighboring curvature radii and the current curvature radius, a reliability associated with each of the plurality of routes, and select, as the final traveling route, whichever route among the plurality of routes is associated with a highest reliability. The at least one instruction, when executed by the processor, is configured to cause the vehicle to, based on the determination that the vehicle has entered the junction, switch to a route correction mode, determine a curvature radius difference between each of the neighboring curvature radii and the current curvature radius, determine a shortest distance between each of the plurality of routes and a current position of the vehicle, and, based on the curvature radius difference and the shortest distance, determine a reliability associated with each of the plurality of routes. The at least one instruction, when executed by the processor, is configured to cause the vehicle to, based on at least one of the shortest distances being equal to or greater than a preset threshold distance, end the route correction mode.

The final traveling route is selected based on shapes respectively corresponding to the plurality of routes and a shape corresponding to the current lane. The at least one instruction, when executed by the processor, is configured to cause the vehicle to determine neighboring regression polynomials representing respective shapes of the plurality of routes, determine a current regression polynomial representing a shape of the current lane, determine, based on the neighboring regression polynomials and the current regression polynomial, a reliability associated with each of the plurality of routes, and select, as the final traveling route, whichever route among the plurality of routes is associated with a highest reliability. The at least one instruction, when executed by the processor, is configured to cause the vehicle to detect a lane line of the current lane, generate, based on the lane line, lane line information, determine, based on the navigation map, the neighboring regression polynomials, and determine, based on the lane line information, the current regression polynomial.

The at least one instruction, when executed by the processor, is configured to cause the vehicle to, based on the determination that the vehicle has entered the junction, switch to a route correction mode, determine, for each of the plurality of routes, a difference between a neighboring regression polynomial representing the corresponding route and the current regression polynomial, and determine, based on the difference, a reliability associated with each of the plurality of routes. The at least one instruction, when executed by the processor, is configured to cause the vehicle to determine a shortest distance between each of the plurality of routes and a current position of the vehicle, and, based on at least one of the shortest distances being equal to or greater than a preset threshold distance, end the route correction mode.

Effects that may be obtained from the present disclosure are not limited to those described above, and other effects that have not been described will be clearly understood by those skilled in the technical field to which the present disclosure pertains from the following description.

### BRIEF DESCRIPTION OF THE DRAWINGS

The above and other objects, features and advantages of the present disclosure will become more apparent to those of ordinary skill in the art by describing examples thereof in detail with reference to the accompanying drawings, in which:

FIG. 1 is an exemplary block diagram showing a first vehicle (100);

FIG. 2 is an exemplary view showing a difference in speed limits between a main line and a ramp classified based on a junction (D);

FIG. 3 is an exemplary block diagram showing a configuration of a first processor (152);

FIG. 4 is an exemplary view showing the shortest distances (L1, L2) to each nearby route with respect to a current position;

FIG. 5 is an exemplary block diagram showing a second vehicle (500);

FIG. 6 is an exemplary block diagram showing a configuration of a second processor 552 shown in FIG. 5;

FIG. 7 is an exemplary flowchart showing a method of controlling the first vehicle (100);

FIG. 8 is an exemplary flow chart showing a method of controlling the second vehicle (500); and

FIG. 9 shows an example computing system.

### DETAILED DESCRIPTION

Hereinafter, examples of the present disclosure will be described in detail with reference to the accompanying drawings so that those skilled in the art may easily implement the present disclosure. However, the present disclosure may be implemented in various ways and is not limited to the examples described therein.

In describing examples of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an example could be termed a second element in another example, and, similarly, a second element in an example could be termed a first element in another example, without departing from the scope of the present disclosure.

In the present disclosure, elements that are distinguished from each other are for clearly describing each feature, and do not necessarily mean that the elements are separated. That is, a plurality of elements may be integrated into one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the way of attaining them will become apparent with reference to examples described below in detail in conjunction with the accompanying drawings. Examples, however, may be embodied in many different forms and should not be constructed as being limited to example examples set forth herein. Rather, these examples are provided so that this disclosure will be complete and will fully convey the scope of the disclosure to those skilled in the art.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor may read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium to be executed on a computer. The medium may either continuously store a computer-executable program or temporarily store the program for execution or download. Furthermore, the medium may be a variety of recording or storage means in the form of a single hardware device or multiple combined hardware devices and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on the feature of real-time route adjustment at junctions. For example, when the vehicle corrects the guided route to remain on the main line rather than a branch route, the autonomous driving system may adjust speed-limit control, modify acceleration or braking profiles, or change forward-collision-warning timing to match the corrected route. In addition, sensor-selection logic and perception ranges may be updated based on the corrected traveling path (e.g., extending look-ahead sensing along the main line instead of the branch route). Based on these features, various autonomous driving operations—such as braking control, acceleration change-rate control, or alert timing—may be controlled to ensure consistency with the corrected route.

One or more auxiliary devices (e.g., engine brake, exhaust brake, hydraulic retarder, electric retarder, regenerative brake) may also be controlled based on the feature of real-time route adjustment at junctions. For example, when the corrected route indicates continued travel on the main line rather than a slower branch route, the vehicle may reduce use of the engine brake or retarder to maintain an appropriate cruising speed. Conversely, if the corrected route corresponds to a ramp with a lower speed limit, the vehicle may increase regenerative braking or engage a retarder earlier to safely slowdown in accordance with the updated route.

One or more communication devices (e.g., a modem, network adapter, radio transceiver, or antenna supporting Ethernet, Wi-Fi, NFC, Bluetooth, LTE, 5G NR, or V2X) may also be controlled based on the feature of real-time route adjustment at junctions. For example, when the corrected route indicates that the vehicle will remain on the main line, the system may prioritize V2X communication with vehicles ahead on the same roadway segment. Conversely, if the corrected route corresponds to a ramp, the vehicle may adjust its communication profile to obtain ramp-specific traffic or hazard information or increase V2X broadcasts indicating its intended deceleration or lane change.

Minimum risk maneuver (MRM) operations may also be controlled based on the feature of real-time route adjustment at junctions. For example, when the corrected route indicates that the vehicle remains on the main line rather than entering a branch route, an MRM initiated because the driver fails to respond to an intervention request may adjust its fallback stopping location to a safe area along the main line. Conversely, if the corrected route corresponds to a ramp with a lower speed limit, the MRM may reduce its stopping distance or begin deceleration earlier to reach a minimum-risk state appropriate for the ramp geometry. During the MRM, one or more processors may continue to control the vehicle's driving operation for a set period of time to maintain the minimum-risk condition.

Biased driving operations may also be controlled based on the feature of real-time route adjustment at junctions. For example, when the corrected route indicates continued travel on the main line instead of a branch route, the driving control apparatus may adjust the biased target lateral distance to favor the side of the lane associated with the corrected route, such as biasing the vehicle slightly toward the left side of the main line to prepare for upcoming traffic flow. Conversely, if the corrected route corresponds to a ramp, the apparatus may bias the lateral position toward the side leading into the ramp to support a smoother and safer merging maneuver. In such cases, the driving control apparatus maintains an intentionally adjusted lateral distance from the lane center or another reference point to improve stability and safety under the updated driving conditions.

One or more sensors may also be controlled based on the feature of real-time route adjustment at junctions. For example, when the corrected route indicates continued travel on the main line, the vehicle may adjust camera or RADAR focus ranges to prioritize forward sensing along the main line and widen LIDAR coverage for higher-speed traffic. Conversely, if the corrected route corresponds to a ramp, the system may narrow the forward sensing range, increase detection sensitivity for closer obstacles, or activate blind-spot and side-looking sensors to support merging onto the ramp. In this manner, sensor operation is aligned with the driving conditions associated with the corrected route.

An autonomous driving level and autonomous driving activation or deactivation may also be controlled based on the feature of real-time route adjustment at junctions. For example, when the corrected route indicates continued travel on the main line at higher speeds, the driving control apparatus may increase the required user attentiveness or downgrade the autonomous driving level to ensure driver readiness. Conversely, when the corrected route corresponds to a ramp with lower speeds and simpler geometry, the system may maintain or re-enable a higher autonomous driving level. In some cases, the apparatus may also adjust display restrictions or alert timing based on the updated route to support safe activation or deactivation of autonomous driving.

Hereinafter, examples of the present disclosure will be described with reference to the accompanying drawings.

First, some terms used in examples of the present disclosure are defined.

A main line is a basic lane on which a vehicle travels on a highway and may be distinguished from entrance/exit ramps and auxiliary lanes (an acceleration lane and a deceleration lane).

The ramp is a road connecting the main line to the entrance/exit ramps, refers to a road connected with the main line at an interchange (IC) and a junction (JC), and has many curved structures.

A junction is a point at which the main line branches into the ramps or the auxiliary lanes and may be used in common at the IC or the JC.

A nearby route is a route split at the junction and may include one or more main lines and one or more ramps or one or more main lines and one or more auxiliary lanes. Hereinafter, a ramp and an auxiliary lane are collectively referred to as a ramp.

According to the present disclosure, when a vehicle approaches a roadway split such as a highway junction where a main line continues straight and a ramp branches away, a navigation system may guide the vehicle toward the ramp while the vehicle, in actual operation, continues along the main line if no steering input is applied. In such situations, the guided route and the vehicle's actual traveling lane may become misaligned, causing the vehicle to operate according to the speed limit of the guided ramp rather than the higher speed limit of the main line, potentially disrupting surrounding traffic. To address this issue, the present disclosure enables the vehicle to rapidly determine the lane on which it is traveling by comparing the geometric characteristics of lane-line information sensed by onboard cameras or other sensors with the shapes of multiple candidate routes obtained from map data. By evaluating factors such as curvature similarity and positional proximity between the sensed lane and each candidate route, the vehicle may select the route that most closely corresponds to the current lane. As a result, the navigation guidance may be promptly updated to the correct route, enabling the vehicle to apply an appropriate speed limit and maintain consistent driving behavior during semi-autonomous or autonomous operation.

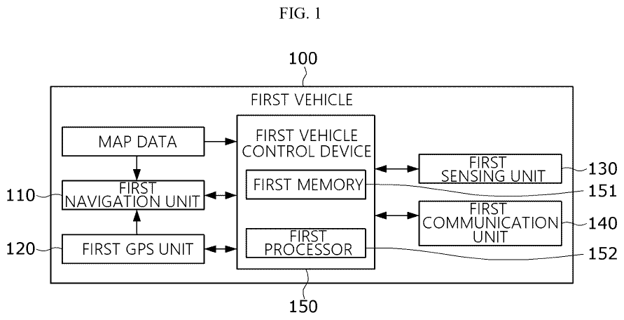

FIG. 1 is an exemplary block diagram showing a first vehicle 100 according to one example of the present disclosure.

Referring to FIG. 1, the first vehicle 100 according to one example of the present disclosure may include a first navigation unit 110, a first global positioning system (GPS) unit 120, a first sensing unit 130, a first communication unit 140, and a first vehicle control device 150.

As shown in FIG. 1, the first vehicle 100 is a vehicle capable of autonomous driving and may provide a navigation-based smart cruise control (NSCC) function that automatically adjusts speed using navigation map data during autonomous driving and a highway driving assist 2 (HDA 2) function that supports semi-autonomous driving on highways. Accordingly, the first vehicle 100 may provide functions related to autonomous driving, such as cruise control, lane keeping assist (LKA), lane change assist, adaptive cruise control (ACC), forward collision warning (FCW), or blind-spot detection (BSD), etc. In the present disclosure, autonomous driving is Level 1 or higher autonomous driving, and specifically, may be Level 2 or 2.5 autonomous driving.

The map data (e.g., a navigation map) is provided to the first navigation unit 110 and the first vehicle control device 150. The map data may be stored in the first vehicle 100 or received from a control server (not shown) that provides an autonomous driving service. The map data may not provide road curvature information. Alternatively, the map data may not be a high-definition map.

The first navigation unit 110 may provide at least one of map information, route information according to destination setting, information on various objects on the route, lane information, and current position information of the vehicle in a displayable form based on the input map data (e.g., traffic-sign icons, road-geometry overlays, or junction-level guidance panels, etc.). The first navigation unit 110 may be implemented as a portion of an audio video navigation telematics (AVNT) system including a display device or an independent device (e.g., an integrated cluster-display module or a stand-alone navigation controller, etc.).

The first GPS unit 120 may receive satellite signals to measure a position, speed, and direction of the first vehicle 100. The first GPS unit 120 may receive signals from a plurality of GPS satellites, calculate the position of the first vehicle 100, and transmit the calculated position to the first navigation unit 110 and the first vehicle control device 150. The first navigation unit 110 or the first vehicle control device 150 may perform route guidance, position tracking, and the like based on the received position (e.g., updating map-matching confidence, refining vehicle heading, or recalculating ETA, etc.).

The first sensing unit 130 may detect lane lines of a current lane on which the first vehicle 100 is traveling and generate lane line information related to the detected lane lines (e.g., lane width, lane curvature, lane-type classification, or boundary-confidence scores, etc.). The first sensing unit 130 may transmit the detected lane lines and the generated lane line information to the first vehicle control device 150.

The first sensing unit 130 may include at least one of one or more cameras, radars, lidars, ultrasonic sensors, infrared sensors, or stereo-vision sensors, etc. In autonomous vehicles, more precise lane line recognition is possible using a sensor fusion technique, and vehicle-to-everything (V2X) communication may be additionally used (e.g., vehicle-to-vehicle (V2V), vehicle-to-infrastructure (V2I), or vehicle-to-network (V2N), etc.).

For example, when the first sensing unit 130 includes one or more cameras, the cameras may be installed outside the first vehicle 100 to capture and acquire an image of the surroundings of the first vehicle 100, and the first sensing unit 130 may image-process and analyze the image to generate lane line information. The lane line information may include many pieces of information, such as a regression equation, its coefficients, and the like, necessary for calculating positions (x and y coordinates) of lane lines, the type (solid lines, dashed lines, dotted lines, center line, edge marking, etc.), a width of the lane line, and a curvature of the lane line.

The first communication unit 140 may include one or more communication modules that communicate with one or more external devices or one or more external vehicles through a wired or wireless communication network. The wired or wireless communication network may be established by at least one of wireless LAN (WLAN), wireless broadband (WiBro), Wi-Fi (Wi-Fi0), world interoperability for microwave access (WiMAX), high speed downlink packet access (HSDPA), code division multi access (CDMA), enhanced voice-data optimized or enhanced voice-data only (EV-DO), wideband CDMA (WCDMA), high speed downlink packet access (HSUPA), high speed uplink packet access (HSUPA), 3G, long term evolution (LTE), cellular, wireless access in vehicular environment (WAVE), and dedicated short range communication (DSRC), or 5G NR, etc.

In addition, the first communication unit 140 may communicate with a mobile terminal of a user through a short-range communication network. The short-range communication network may be established by Bluetooth low energy (BLE) communication, NFC communication, RFID communication, UWB communication, or ZigBee communication, etc.

In addition, the communication unit 140 may communicate with other devices (e.g., an electronic control unit (ECU), external storage media, an onboard diagnostic (OBD) module, or an infotainment controller, etc.) in the first vehicle 100 through various wired communications such as controller area network (CAN) communication, local interconnect network (LIN) communication, a universal serial bus (USB), a high definition multimedia interface (HDMI), a digital visual interface (DVI), recommended standard232 (RS-232), power line communication, a plain old telephone service (POTS), Ethernet-based automotive e communication (e.g., 100BASE-T1), or FlexRay communication, etc.

The first vehicle control device 150 is an ECU for supporting the first vehicle 100 to travel autonomously on a highway, for example, an advanced driver assistance system (ADAS) controller. The first vehicle control device 150 may include a first memory 151 and a first processor 152.

The first memory 151 may store at least one program (e.g., an operating system, software, firmware, middleware, application, perception algorithms, path-planning algorithms, or sensor-fusion logic, etc.), various types of data, and at least one command for controlling the first vehicle 100 or the first vehicle control device 150 and may load the program, read or write data, or perform an operation corresponding to the command in response to the request of the first processor 152. The first memory 151 may include a volatile memory and a nonvolatile memory.

The first processor 152 may perform overall control of the vehicle 100 according to an input command. The command may be input by the first memory 151 or the first communication unit 140. For example, the first processor 152 may execute programs or commands stored in the first memory 151 to control the operation of other components (hardware or software) and perform data processing and calculations. In addition, the first processor 152 may load commands or data received from other components into a volatile memory, process the commands or data stored in the volatile memory, and store the processing result in a nonvolatile memory.

The first processor 152 may include, for example, at least one central processing unit (CPU), at least one microprocessor, at least one digital signal processor (DSP), at least one application specific integrated circuit (ASIC), at least one programmable logic device (PLD), and at least one field programmable gate array (FPGA), or a neural-network accelerator, etc.

The first processor 152 may predict that the first vehicle 100 that is autonomously traveling along the main line may deviate from the traveling route guided by the first navigation unit 110 when entering the junction on a navigation map. For example, when the first vehicle 100 performs Level 2 autonomous driving on a highway, even when the first navigation unit 110 guides the traveling route to enter a ramp, the first vehicle 100 may travel along the main line (e.g., due to driver inattention, insufficient steering input, or lane-centering bias, etc.), and thus the first processor 152 may predict that the first vehicle may deviate from the traveling route when entering the junction.

Accordingly, the first processor 152 may select one of the plurality of nearby routes as a final traveling route to be guided by the first navigation unit 110 based on a curvature radius of each of the plurality of nearby routes split at the junction (hereinafter referred to as “neighboring curvature radii”) and a curvature radius of a current lane (i.e., the main line) on which the first vehicle 100 is actually traveling (hereinafter referred to as a “current curvature radius”) (e.g., a curvature radius derived from lane-line detection, polynomial regression, or sensor-fusion-based geometry estimation, etc.).

This means that, even when the first navigation unit 110 guides the traveling route so that the first vehicle enters another highway or general road at the junction in order to reach a destination, the first vehicle 100 that is traveling autonomously deviates from the traveling route because the first vehicle 100 travels while keeping the main line when no driver intervention is present (e.g., the driver does not turn the steering wheel, the steering torque request is ignored, or hands-off driving persists, etc.), and thus the first processor 152 determines the current lane as quickly as possible and guides the first vehicle to a route modified from the first navigation unit 110.

In addition, although the speed limit of the main line and the speed limit of the ramp among the plurality of nearby routes are different, the first navigation unit 110 guides the ramp as the traveling route, and thus the NSCC or HDA2 function allows the first vehicle 100 to travel according to the speed limit set on the ramp. Accordingly, the first processor 152 may determine the current lane (i.e., the main line) so that the first vehicle travels according to the speed limit of the main line as quickly as possible (e.g., increasing target speed, overriding ramp-speed guidance, or resuming highway-speed cruise control, etc.).

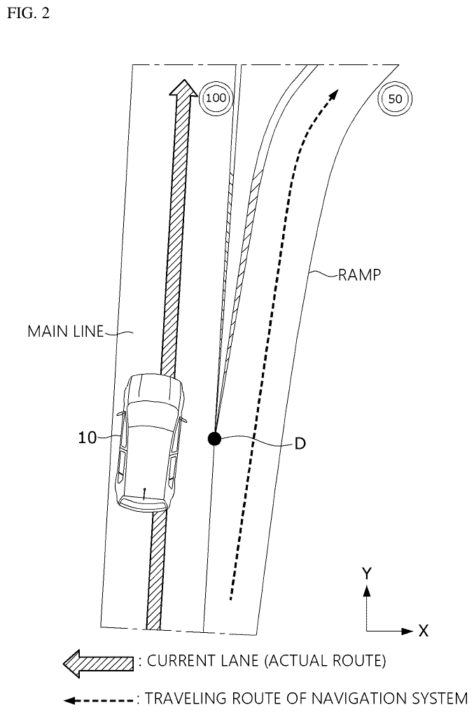

FIG. 2 is an exemplary view showing a difference in speed limits between a main line and a ramp classified based on a junction D.

Referring to FIG. 2, the first navigation unit 110 may guide the ramp with the speed limit set at 50 km/h as the traveling route, but the first vehicle 100 may travel while keeping the main line at the junction D by the NSCC or HDA2 function, and thus the first vehicle may deviate from the route (e.g., continuing straight due to lane-centering logic, insufficient driver steering input, or stability-control bias, etc.). For example, the main line has a speed limit of 100 km/h, however, the first vehicle 100 adjusts a speed to the speed limit of 50 km/h provided by the first navigation unit 110 by an autonomous driving assistance function, resulting in traffic inconvenience to nearby vehicles that are traveling on the main line (e.g., causing sudden speed mismatches, increased tailgating, or unnecessary braking by following vehicles, etc.). Accordingly, when the first vehicle 100 is close to the junction D, the first processor 152 may quickly identify the current lane on which the first vehicle 100 is actually traveling, that is, the main line, among a plurality of nearby routes and transmit the current route to the first navigation unit 110.

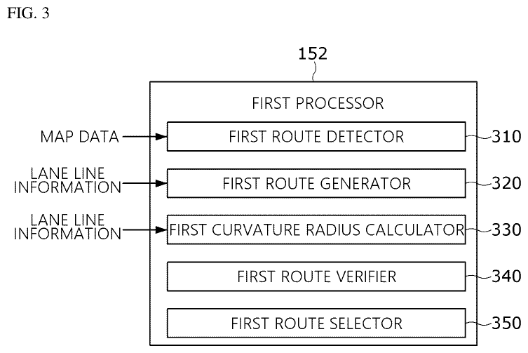

FIG. 3 is an exemplary block diagram showing a configuration of the first processor 152 according to one example of the present disclosure. Each component shown in FIG. 3 may be a physically separated device (e.g., a CPU, GPU, or neural-network accelerator, etc.) or a single device.

Referring to FIG. 3, the first processor 152 according to one example of the present disclosure may include a first route detector 310, a first route generator 320, a first curvature radius calculator 330, a first route verifier 340, and a first route selector 350.

The first route detector 310 receives data on a global route to the destination from the first navigation unit 110. In addition, the first route detector 310 may process map data related to the navigation map, and when it is determined that the first vehicle 100 has entered the junction on the traveling route, the first route detector 310 may switch to a route correction mode and detect the junction and a plurality of nearby routes split at the junction. In the case of FIG. 2, there are two nearby routes split at the junction D (e.g., a main-line continuation path and a branch ramp path, etc.).

For example, the first route detector 310 may identify the junction based on a node (or a point) and a segment (or a link) included in the map data. That is, since a road in the map data is composed of a plurality of nodes and links and the junction is connected to one node by a plurality of links, the first route detector 310 may determine whether to enter the junction therefrom (e.g., by detecting a node with multiple outgoing links, or a sudden change in link geometry, etc.).

Alternatively, the first route detector 310 may identify the junction from attribute information of the junction included in the map data. Since the attribute information of the junction includes a ramp, a deceleration lane, direction information, and the like, the first route detector 310 may check the junction from the attribute information (e.g., using ramp flags, segment-type codes, or lane-connection metadata, etc.).

The first route generator 320 may generate an actual route for vehicle control based on the lane line information received from the first sensing unit 130 based on the lane on which the first vehicle 100 is currently actually traveling (hereinafter referred to as a “current lane”). That is, the first route generator 320 may generate an actual route from the centers of two-lane lines positioned on both sides of the current lane (e.g., computing a midline from left-right lane boundaries or using regression-derived center points, etc.). In the case of FIG. 2, the current lane may be a main line.

The first curvature radius calculator 330 may calculate a current curvature radius Ra for the current lane on which the first vehicle is traveling and neighboring curvature radii R1 and R2 for each of the plurality of nearby routes detected by the first route detector 310 (e.g., one radius for the main line and one for the branch ramp, etc.).

The first curvature radius calculator 330 may calculate the curvature radius Ra for the current lane (or a lane line of the current lane) based on the lane detected by the first sensing unit 130. For example, since two lane lines at both sides are detected by a camera, the camera or the first curvature radius calculator 330 fits a road curve of the current lane with a second-order polynomial y=C₂x²+C₁x+C₀ using coordinates of center points of the two lane lines, and then performs regression analysis to obtain coefficients C₂, C₁, and C₀. The first curvature radius calculator 330 may calculate the curvature from the coefficients C₂, C₁, and C₀ and calculate the curvature radius Ra from the reciprocal of the curvature (e.g., applying 1/|curvature|, fitting with least-squares regression, or smoothing the polynomial for noise reduction, etc.).

In addition, the first curvature radius calculator 330 may calculate the neighboring curvature radii R₁ and R₂ by applying road centerline coordinates (x, y) provided from the map data to a three-point method, a circle fitting method, or a regression polynomial. That is, the first curvature radius calculator 330 may calculate the curvature radius R₁ of the main line and the curvature radius R₂ of the ramp (e.g., using map-derived polyline geometry, spline interpolation, or linked-node curvature estimation, etc.).

The first route verifier 340 may calculate the reliability of the plurality of nearby routes based on each of the plurality of calculated neighboring curvature radii R₁ and R₂ and the current curvature radius Rₐ.

For example, the first route verifier 340 calculates differences D₁ and D₂ between each of the neighboring curvature radii R₁ and R₂ and the current curvature radius Rₐ (hereinafter referred to as a “curvature radius difference”) using Equation 1.

$${D}_{1} = \vert {R}_{1} - {R}_{a} \vert , {D}_{2} = \vert {R}_{2} - {R}_{a} \vert \qquad [ Equation 1 ]$$

In addition, the first route verifier 340 calculates the shortest distances L1 and L2 between each of the nearby routes and the current position of the first vehicle 100. The first route verifier 340 may calculate the shortest distances L1 and L2 to each nearby route with respect to the current position detected by the first GPS unit 120 (e.g., computing orthogonal projection distances, map-matched offsets, or lateral geometric deviations, etc.).

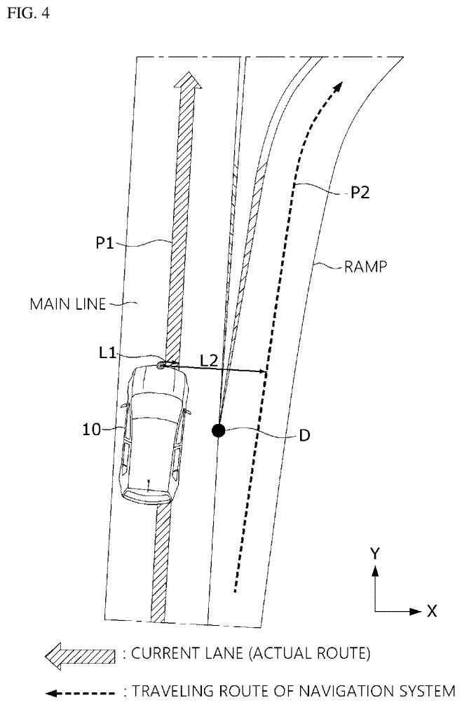

FIG. 4 is an exemplary view showing the shortest distances L1 and L2 to each nearby route with respect to a current position.

Referring to FIG. 4, when each of lines indicated in the middle of a plurality of nearby routes is a centerline, the shortest distances L1 and L2 may be vertical distances from the current position of the first vehicle 100 to the centerlines (e.g., perpendicular offsets derived from map geometry, sensor-fused lane positioning, or GPS-matched coordinates, etc.). In FIG. 4, actual positions at which the shortest distances L1 and L2 are measured may be the same.

The first route verifier 340 may calculate the reliability of the plurality of nearby routes that are being displayed on the navigation map based on the difference in curvature radii R₁ and R₂ and the shortest distances L1 and L2 calculated for the nearby routes (e.g., combining curvature similarity, lateral proximity, or path-likelihood metrics, etc.).

Equation 2 is a formula for calculating uncertainty (or cost) for each nearby route.

$${C}_{1} = α {D}_{1} + ( 1 - α ) {L}_{1} , \qquad [ Equation 2 ]$$

$${C}_{2} = α {D}_{2} + ( 1 - α ) {L}_{2}$$

Referring to Equation 2, C₁ denotes uncertainty for P₁, C₂ denotes uncertainty for P₂, and a denotes a weight between two variables D₁ and L1 or variables D₂ and L2 and has a value of 0 to 1 (e.g., α=0.3, 0.5, or 0.7 depending on configuration, etc.). The first route verifier 340 may determine that a nearby route with a lower value among C₁ and C₂ has higher reliability (e.g., the route with minimum cost or best geometric match, etc.).

The first route selector 350 may select a nearby route with the highest reliability among the plurality of nearby routes, that is, a nearby route with the lowest uncertainty, as a final traveling route to be guided by the first navigation unit 110. Accordingly, the first route selector 350 may request the first navigation unit 110 to guide the selected final traveling route, that is, to correct the previously guided traveling route (e.g., switching guidance from a ramp path to a main-line path or vice versa, etc.).

In addition, the first route selector 350 may finish the route correction mode when the vertical distance L2 from the current position of the first vehicle 100 to another nearby route is a preset threshold distance (e.g., 15 meters, which may be increased or decreased) or more (e.g., to prevent unnecessary recalculations, oscillating corrections, or lingering junction logic, etc.).

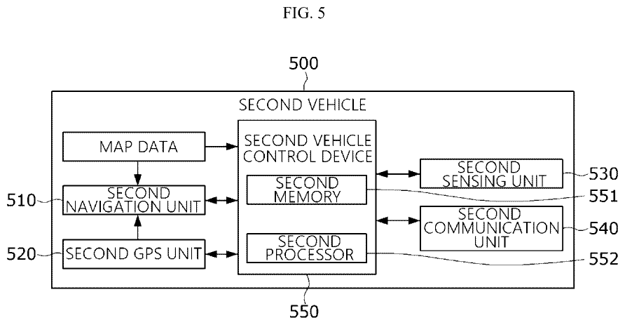

FIG. 5 is an exemplary block diagram showing a second vehicle 500 according to another example of the present disclosure.

Referring to FIG. 5, the second vehicle 500 according to one example of the present disclosure may include a second navigation unit 510, a second GPS unit 520, a second sensing unit 530, a second communication unit 540, and a second vehicle control device 550.

Since the second navigation unit 510, the second GPS unit 520, the second sensing unit 530, the second communication unit 540, and the second vehicle control device 550 shown in FIG. 5 are similar to or the same as the navigation unit 110, the first GPS unit 120, the first sensing unit 130, the first communication unit 140, and the first vehicle control device 150 described with reference to FIGS. 1 to 4, the detailed descriptions thereof will be omitted.

The second vehicle 500 shown in FIG. 5 is a vehicle capable of autonomous driving and may provide a cruise control function such as NSCC or a semi-autonomous driving function on a highway such as HDA2 (e.g., supporting lane keeping, adaptive cruise, or active steering assist, etc.).

The map data is provided to the second navigation unit 510 and the second vehicle control device 550. The map data may be stored in the second vehicle 500 or received from a control server (not shown) that provides an autonomous driving service (e.g., over LTE, 5G, or vehicle-to-network communication, etc.).

The second navigation unit 510 is a navigation system that provides at least one of map information, route information according to destination setting, information on various objects on the route, lane information, and current position information of the vehicle in a displayable form based on the input map data (e.g., junction layouts, road attributes, or hazard indicators, etc.).

The second GPS unit 520 may measure a position, speed, and direction of the second vehicle 500 and transmit the measured results to the second processor 552 (e.g., updated latitude/longitude, heading angle, or velocity vector, etc.).

The second sensing unit 530 may detect lane lines of a current lane on which the second vehicle 500 is traveling and generate lane line information related to the detected lane lines. The second sensing unit 530 may transmit the detected lane lines and the generated lane line information to the second vehicle control device 550.

The second sensing unit 530 may include at least one of one or more cameras, radars, and lidars. For example, when the second sensing unit 530 includes one or more cameras, the cameras may capture an image of a surrounding environment of the second vehicle 500 to acquire the image, and the second sensing unit 530 may image-process and analyze the image to generate lane line information (e.g., curvature, lane width, boundary type, or confidence score, etc.). The lane line information may include many pieces of information, such as a regression equation, its coefficients, and the like, related to positions (x and y coordinates) and the type (solid lines, dotted lines, center line, etc.) of lane lines, a width of the lane line, and a curvature of the lane line.

The second communication unit 540 may include a communication module that communicates with one or more external devices or one or more external vehicles through a wired/wireless communication network or a short-range communication network (e.g., Wi-Fi, LTE, 5G NR, Bluetooth, or UWB, etc.). In addition, the second communication unit 540 may communicate with other devices in the second vehicle 500 through various wired communications such as a CAN, a LIN, a USB, an HDMI, a DVI, etc.

The second vehicle control device 550 is an ECU that supports the second vehicle 500 to travel autonomously on a highway and may be, for example, an ADAS controller. The second vehicle control device 550 may include a second memory 551 and a second processor 552.

The second memory 551 may store at least one program, various types of data, and at least one command for controlling the second vehicle 500 or the second vehicle control device 550 and load the program, read or write data, or perform an operation corresponding to the command in response to the request of the second processor 552 (e.g., executing path-planning logic, logging sensor data, or updating perception models, etc.). The second memory 551 may include a volatile memory and a nonvolatile memory.

The second processor 552 may perform overall control of the second vehicle 500 according to an input command. The second processor 552 may predict that the second vehicle 500 that is autonomously traveling along the main line may deviate from the traveling route guided by the second navigation unit 510 when entering the junction on a navigation map (e.g., due to centered-lane travel, missed steering adjustment, or navigation misalignment, etc.).

For example, when the second vehicle 500 performs Level 2 autonomous driving on a highway, even when the second navigation unit 510 guides the traveling route to enter a ramp, the second vehicle 500 may travel along the main line, and thus the second processor 552 may predict that the first vehicle may deviate from the traveling route when entering the junction. Accordingly, the second processor 552 may select one of the plurality of nearby routes as the final traveling route to be guided by the second navigation unit 510 based on the shape of each of the plurality of nearby routes split at the junction and the shape of the current lane on which the second vehicle 500 is traveling (e.g., comparing curvature, centerline geometry, or polynomial shape models, etc.).

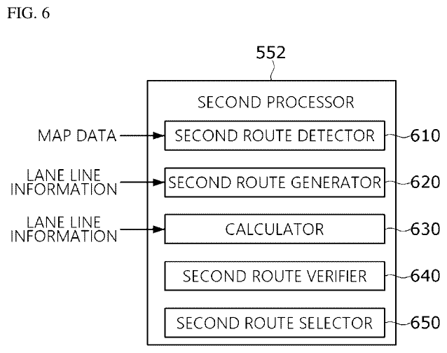

FIG. 6 is an exemplary block diagram showing a configuration of a second processor 552 shown in FIG. 5.

Each component shown in FIG. 6 may be a physically separated device or a single device (e.g., implemented as individual processors, integrated on a system-on-chip, or distributed across multiple ECUs, etc.). Referring to FIG. 6, the second processor 552 according to one example of the present disclosure may include a second route detector 610, a second route generator 620, a calculator 630, a second route verifier 640, and a second route selector 650.

The second route detector 610 receives data on a global route to the destination from the second navigation unit 510. In addition, the second route detector 610 may process map data related to the navigation map, and when it is determined that the second vehicle 500 has entered the junction on the traveling route, the second route detector 610 may switch to a route correction mode and detect the junction and a plurality of nearby routes split at the junction. In the case of FIG. 2, two nearby routes split at the junction D are a main line and a ramp (e.g., a straight-through path and a curved exit path, etc.).

The second route generator 620 may generate an actual route based on lane line information of the current lane on which the second vehicle 500 is currently actually traveling. The actual route is a route for lane line control. That is, the second route generator 620 may generate an actual route from the centers of two-lane lines positioned on both sides of the current lane (e.g., by averaging lane boundary coordinates or applying polynomial fitting to derive a midline, etc.). In the case of FIG. 2, the current lane may be a main line.

The calculator 630 may calculate a regression polynomial representing the shape of each of the plurality of nearby routes detected by the second route detector 610 (hereinafter referred to as a “neighboring regression polynomial”). For example, the calculator 630 may calculate the neighboring regression polynomial by fitting road centerline coordinates (i.e., node coordinates) included in the map data to a second-order polynomial (e.g., least-squares fitting, spline-based smoothing, or segment-by-segment polynomial stitching, etc.).

Equation 3 is a first neighboring regression polynomial y1 and a second neighboring regression polynomial y2 calculated by polynomial regression.

$$y 1 = {C}_{21} {x}^{2} + {C}_{11} x + {C}_{01} \qquad [ Equation 3 ]$$

$$y 2 = {C}_{22} {x}^{2} + {C}_{12} x + {C}_{02}$$

In Equation 3, y1 is a second-order polynomial representing where the centerline of the main line P₁ is positioned at an x position, and C₂₁, C₁₁, and C₀₁ denote coefficients defining the curve shape of the main line P₁. In addition, y2 is a second-order polynomial representing where the centerline of the ramp P₂ is positioned at the x position, and C₂₂, C₁₂, and C₀₂ denote coefficients that define the curve shape of the ramp P₂, which may be calculated by the regression method.

In addition, the calculator 630 may calculate a regression polynomial that represents the shape of the current lane on which the second vehicle 500 is traveling (hereinafter referred to as a “current regression polynomial”). For example, the calculator 630 may calculate the current regression polynomial for the current lane from the lane line information detected by the camera of the second sensing unit 530 (e.g., using lane center points, edge detection, or camera-based perspective transformation, etc.). Equation 4 represents a current regression polynomial ya.

$$ya = {C}_{2 a} {x}^{2} + {C}_{1 a} x + {C}_{0 a} \qquad [ Equation 4 ]$$

Referring to Equation 4, ya is a second-order polynomial representing where the centerline of the current lane is positioned at the x position, and C₂a, C₁ₐ, and C₀ₐ denote coefficients defining the curve shape of the current lane line, which may be calculated from the camera.

The second route verifier 640 may use each of the neighboring regression polynomials y1 and y2 and the current regression polynomial ya to add a difference in change (i.e., slope) between the nearby route and the current route (e.g., slope differences at sampled x-positions or derivative-based curvature comparisons, etc.) and may calculate the reliability of each nearby route based on the added result. To this end, the second route verifier 640 may calculate uncertainty for each nearby route using Equation 5.

$${D}_{1} = {\sum }_{x} \vert ( {C}_{21} {x}^{2} + {C}_{11} x ) - ( {C}_{2 a} {x}^{2} + {C}_{1 a} x ) \vert \qquad [ Equation 5 ]$$

$${D}_{2} = {\sum }_{x} \vert ( {C}_{22} {x}^{2} + {C}_{12} x ) - ( {C}_{2 a} {x}^{2} + {C}_{1 a} x ) \vert$$

Referring to Equation 5, D₁ denotes uncertainty for P₁, (C₂₁x²+C₁₁X) denotes the slope of the centerline of the main line P1, and denotes the slope of the centerline of the current lane. D₂ denotes uncertainty for P2, (C₂₂x²+C₁₂x) denotes the slope of the centerline of the ramp P2, and (C₂ₐx²+C₁ₐx) denotes the slope of the centerline of the current lane. For example, when D₁<D₂, it means that a difference in shapes between the ramp P2 used to calculate D₂ and the current lane is greater, and thus the shapes of the main line P1 used to calculate D₁, and the current lane are more similar. Accordingly, the second route verifier 640 may determine that the nearby route (e.g., the main line P1) with the smaller value among D₁ and D₂ has higher reliability (e.g., reflecting better geometric alignment, lower slope deviation, or more consistent curvature profile, etc.).

The second route selector 650 may select a nearby route with the highest reliability among the plurality of nearby routes as a final traveling route to be guided by the second navigation unit 510. Accordingly, the second route selector 650 may request the second navigation unit 510 to guide the selected final traveling route (e.g., switching guidance instructions or updating turn-by-turn prompts, etc.).

In addition, the second route selector 650 may finish the route correction mode when the vertical distance L2 from the current position of the second vehicle 500 to another nearby route is a preset threshold distance (e.g., 15 meters, which may be increased or decreased) or more (e.g., when the ramp becomes sufficiently distant or no longer geometrically plausible, etc.).

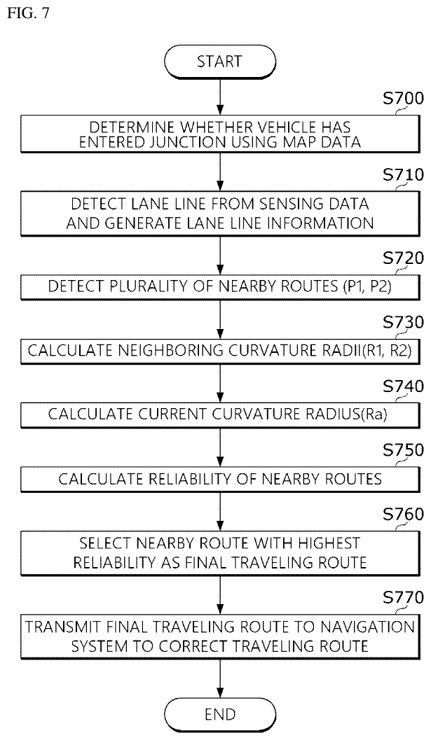

FIG. 7 is an exemplary flowchart showing a method of controlling the first vehicle 100 according to one example of the present disclosure.

Referring to FIG. 7, the first vehicle 100 determines whether the first vehicle 100 has entered the junction using the input navigation map data (S700) (e.g., by detecting a node with multiple outgoing links or a map-based junction attribute, etc.).

When it is determined that the first vehicle 100 has entered the junction, the first vehicle 100 switches to the route correction mode, detects the current lane line from the sensing data acquired by the camera, and generates lane line information on the current lane line (S710) (e.g., curvature, width, or lane-type classification, etc.).

In addition, when it is determined that the first vehicle 100 has entered the junction, the first vehicle 100 detects the plurality of nearby routes P₁ and P₂ split at the junction using the map data (S720) (e.g., extracting centerline geometry or link-level node coordinates, etc.).

The first vehicle 100 calculates the neighboring curvature radii R₁ and R₂ for each of the plurality of detected nearby routes P₁ and P₂ (S730). In operation S730, the neighboring curvature radii R₁ and R₂ may be calculated using the road centerline coordinates (x, y) provided from the map data. The neighboring curvature radii R₁ and R₂ are the curvature radii of the main line and the ramp, respectively (e.g., computed via circle fitting, three-point curvature estimation, or polynomial curvature extraction, etc.).

The first vehicle 100 calculates the current curvature radius Rₐ for the current lane on which the first vehicle 100 is traveling from the lane line information detected by the camera (S740). Alternatively, the current curvature radius Ra may be calculated and provided by the camera (e.g., derived through regression fitting, pixel-coordinate transformation, or curve-slope extraction, etc.).

The first vehicle 100 calculates the reliability of the plurality of nearby routes based on each of the plurality of calculated neighboring curvature radii R₁ and R₂ and the current curvature radius Rₐ (S750). In operation S750, the curvature radius differences D₁ and D₂, which are differences between each of the neighboring curvature radii and the current curvature radius may be calculated, the shortest distances L1 and L2 between each of the nearby routes and the current position of the first vehicle 100 may be calculated, and then, reliability may be calculated based on the calculated curvature radius differences D₁ and D₂ and the shortest distances L1 and L2 for each of the nearby routes (e.g., computing a weighted cost, likelihood score, or geometric similarity metric, etc.).

The first vehicle 100 selects the most reliable nearby route among the plurality of nearby routes as the final traveling route to be guided by the navigation system (S760).

The first vehicle 100 requests the navigation system to guide the final traveling route selected in operation S760, that is, to correct the previously guided traveling route (S770) (e.g., updating guidance prompts, modifying speed-target logic, or refreshing navigation instructions, etc.).

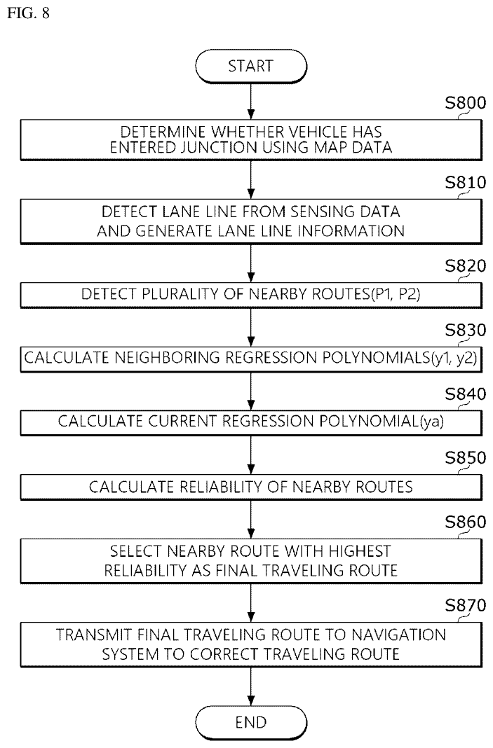

FIG. 8 is an exemplary flow chart showing a method of controlling the second vehicle 500 according to another example of the present disclosure.

Referring to FIG. 8, the second vehicle 500 determines whether the second vehicle 500 has entered the junction using the input navigation map data (S800) (e.g., by detecting a junction node, multiple outgoing links, or a map-based junction attribute, etc.).

When it is determined that the second vehicle 500 has entered the junction, the second vehicle 500 switches to the route correction mode, detects the current lane line from the sensing data acquired by the camera, and generates lane line information on the current lane line (S810) (e.g., curvature, lane width, or lane-type classification, etc.).

In addition, when it is determined that the second vehicle 500 has entered the junction, the second vehicle 500 detects the plurality of nearby routes P1 and P2 split at the junction using the map data (S820) (e.g., identifying centerline geometry, link-level shapes, or ramp attributes, etc.).

The second vehicle 500 calculates the neighboring curvature radii y1 and y2 representing the shape of each of the plurality of detected nearby routes P1 and P2 (S830) (e.g., using polynomial fitting, curve-slope extraction, or map-spline approximation, etc.).

In addition, the second vehicle 500 calculates the current regression polynomial ya representing the shape of the current lane on which the second vehicle 500 is actually traveling (S840) (e.g., derived from camera-detected lane boundaries or fused lane-center estimates, etc.).

The second vehicle 500 calculates the reliability of the plurality of nearby routes based on the plurality of calculated neighboring regression polynomials y1 and y2 and the current regression polynomial ya (S850). In operation S850, the differences in changes between the nearby routes and the current route may be added using each of the neighboring regression polynomials y1 and y2 and the current regression polynomial ya, and the reliability of each nearby route may be calculated based on the added result (e.g., slope deviation, curvature similarity, or derivative-based geometric matching, etc.).

The second vehicle 500 selects the most reliable nearby route among the plurality of nearby routes as the final traveling route to be guided by the navigation system (S860) (e.g., choosing the path with minimum geometric cost or best polynomial match, etc.).

The second vehicle 500 requests the navigation system to guide the final traveling route selected in operation S860, that is, to correct the previously guided traveling route (S870) (e.g., by updating navigation prompts, modifying speed-limit logic, or refreshing route guidance on the display, etc.).

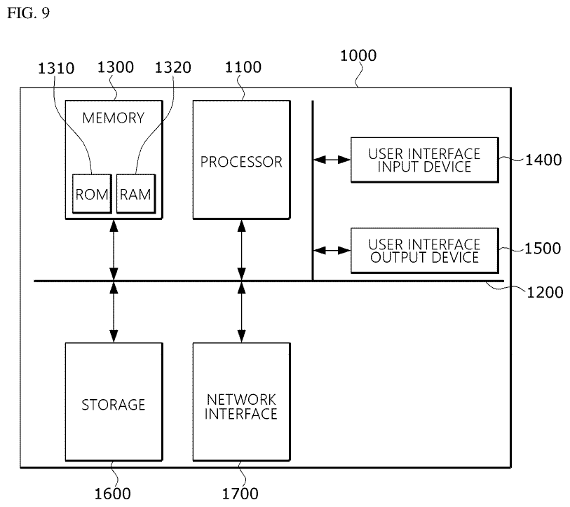

FIG. 9 shows an example computing system (e.g., a computing device of a vehicle or any other apparatus). One or more controllers, processors, etc. described herein, such as one or more components of the first vehicle 100, one or more components of the second vehicle 500, and any other components and devices disclosed herein, may be implemented by or in the computing system as shown in FIG. 9.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to an example of the present disclosure, there is provided a vehicle that allows autonomous driving, the vehicle comprising: a processor; and a memory configured to store one or more programs executed by the processor, wherein, based on the vehicle entering a junction on a navigation map, the processor selects a nearby route from a plurality of nearby routes as a final traveling route to be guided by a navigation system based on a curvature radius of each of the plurality of nearby routes split at the junction (hereinafter referred to as “neighboring curvature radii”) and a curvature radius of a current lane on which the vehicle is traveling (hereinafter referred to as a “current curvature radius”

The processor includes: a route detector configured to switch to a route correction mode and determine the plurality of nearby routes split at the junction when it is determined that the vehicle has entered the junction using map data related to the navigation map;
a curvature radius calculator configured to determine the neighboring curvature radius for each of the plurality of determined nearby routes and the current curvature radius for a current lane on which the vehicle is traveling;
a route verifier configured to determine reliability of the plurality of nearby routes based on each of the plurality of determined neighboring curvature radii and the current curvature radius; and
a route selector configured to select a nearby route with the highest reliability among the plurality of nearby routes as a final traveling route to be guided by the navigation system.

The vehicle further may comprise a sensing unit configured to detect a lane line of the current lane and generate lane line information related to the detected lane line, wherein the curvature radius calculator determines the plurality of neighboring curvature radii based on the map data and determines the current curvature radius based on the lane line information generated by the sensing unit.

The route verifier is configured to: determine a difference between each of the neighboring curvature radii and the current curvature radius (hereinafter referred to as a “curvature radius difference”);
determine a shortest distance between each of the nearby routes and a current position of the vehicle; and
determine the reliability of the plurality of nearby routes displayed on the navigation map based on the curvature radius difference and the shortest distance that are calculated for each of the nearby routes.

The route verifier processes the route correction mode to be finished when at least one of the shortest distances that are calculated for each of the nearby routes is a preset threshold distance or more.

According to another example of the present disclosure, there is provided a vehicle that allows autonomous driving, the vehicle comprising: a processor; and a memory configured to store one or more programs executed by the processor, wherein, based on the vehicle entering a junction on a navigation map, the processor selects a nearby route from a plurality of nearby routes as a final traveling route to be guided by a navigation system based on a shape of each of the plurality of nearby routes split at the junction and a shape of a current lane on which the vehicle is traveling.

The processor includes: a route detector configured to switch to a route correction mode and determine the plurality of nearby routes split at the junction when it is determined that the vehicle has entered the junction using map data related to the navigation map;
a calculator configured to determine a regression polynomial representing a shape of each of the plurality of determined nearby routes (hereinafter referred to as “neighboring regression polynomials”) and a regression polynomial representing the shape of the current lane on which the vehicle is traveling (hereinafter referred to as a “current regression polynomial”);
a route verifier configured to determine reliability of the plurality of nearby routes based on the plurality of determined neighboring regression polynomials and the determined current regression polynomial; and a route selector configured to select a nearby route with the highest reliability among the plurality of nearby routes as a final traveling route to be guided by the navigation system.

The vehicle further may comprise a sensing unit configured to detect a lane line of the current lane and generate lane line information related to the detected lane line, in which, the calculator determines the plurality of neighboring regression polynomials based on the map data and determines the current regression polynomial based on the lane line information detected by the sensing unit.

The route verifier adds a difference in change between each of the nearby routes and the current route using each of the neighboring regression polynomials and the current regression polynomial and determines the reliability of each of the nearby routes based on the added result.

The route verifier processes the route correction mode to be finished when at least one of shortest distances that are determined for each of the nearby routes is a preset threshold distance or more.

According to another example of the present disclosure, there is provided a method of controlling a vehicle that allows autonomous driving, the method comprising: determining whether the vehicle has entered a junction on a navigation map; and selecting, based on determining that the vehicle has entered the junction, a nearby route from a plurality of nearby routes as a final traveling route to be guided by a navigation system based on a curvature radius of each of the plurality of nearby routes split at the junction (hereinafter referred to as “neighboring curvature radii”) and a curvature radius of a current lane on which the vehicle is traveling (hereinafter referred to as a “current curvature radius”).

The selecting of the a nearby route from the plurality of nearby routes as the final traveling route includes: switching to a route correction mode and determining the plurality of nearby routes split at the junction when it is determined that the vehicle has entered the junction using map data related to the navigation map;
determining the neighboring curvature radius for each of the plurality of determined nearby routes;
determining the current curvature radius for the current lane on which the vehicle is traveling;
determining reliability of the plurality of nearby routes based on each of the plurality of determined neighboring curvature radii and current curvature radius; and
selecting a nearby route with the highest reliability among the plurality of nearby routes as a final traveling route to be guided by the navigation system.

The method may further comprise determining a lane line of the current lane and generating lane line information related to the detected lane line, wherein the determining of the current curvature radius includes determining the current curvature radius based on the generated lane line information.

The determining of the reliability includes:
determining a difference between each of the neighboring curvature radii and the current curvature radius (hereinafter referred to as a “curvature radius difference”);
determining a shortest distance between each of the nearby routes and a current position of the vehicle; and
determining uncertainty of the plurality of nearby routes displayed on the navigation map based on the curvature radius difference and the shortest distance that are determined for each of the nearby routes.

The determining of the reliability includes processing the route correction mode to be finished when at least one of the shortest distances that are determined for each of the nearby routes is a preset threshold distance or more.

According to another example of the present disclosure, there is provided a method of controlling a vehicle that allows autonomous driving, the method comprising: determining whether the vehicle has entered a junction on a navigation map; and selecting, based on determining that the vehicle has entered the junction, a nearby route from a plurality of nearby routes as a final traveling route to be guided by a navigation system based on a shape of each of the plurality of nearby routes split at the junction and a shape of a current lane on which the vehicle is traveling.

The selecting of the nearby route from the plurality of nearby routes as the final traveling route includes: switching to a route correction mode and determining the plurality of nearby routes split at the junction when it is determined that the vehicle has entered the junction using map data related to the navigation map;
determining a regression polynomial representing a shape of each of the plurality of determined nearby routes (hereinafter referred to as “neighboring regression polynomials”);
determining a regression polynomial representing a shape of the current lane on which the vehicle is traveling (hereinafter referred to as a “current regression polynomial”);
determining reliability of the plurality of nearby routes based on the plurality of determined neighboring regression polynomials and the determined current regression polynomial; and
selecting a nearby route with the highest reliability among the plurality of nearby routes as a final traveling route to be guided by the navigation system.

The method may further comprise determining a lane line of the current lane and generating lane line information related to the detected lane line,
wherein the determining of the current regression polynomial includes calculating the current regression polynomial based on the generated lane line information.

The determining of the reliability includes adding a difference in change between each of the nearby routes and the current route using each of the neighboring regression polynomials and the current regression polynomial and determining the reliability of each of the nearby routes based on the added result.

The determining of the reliability includes processing the route correction mode to be finished when at least one of shortest distances that are determined for each of the nearby routes is a preset threshold distance or more.

According to the present disclosure, during autonomous driving with a navigation-based speed limit function, it is possible to detect earlier, compared to the conventional GPS value comparison method, instances where the vehicle does not follow the navigation route at a junction without using a high-definition map, thereby enabling faster correction of the navigation route.

Through this, when the vehicle is traveling on a second route, in which a second speed limit higher than a first speed limit set for a first route guided by the navigation system is defined, while operating at the first speed limit, the time and degree of deceleration (jerk) may be reduced, thereby lowering a sense of speed inconsistency.

In addition, according to the present disclosure, it is possible to correct routes around a junction by simply adding an algorithm or logic while continuing to use existing quality sensors as they are, without requiring a high-precision GPS or IMU.

While the exemplary methods of the present disclosure described above are represented as a series of operations for clarity of description, it is not intended to limit the order in which the steps are performed, and the steps may be performed simultaneously or in different order(s) as necessary. To implement the method according to the present disclosure, the described steps may further include other steps, may include remaining steps except for some of the steps, or may include other additional steps except for some of the steps.

The various examples of the present disclosure are not a list of all possible combinations and are intended to describe representative examples of the present disclosure, and the matters described in the various examples may be applied independently or in combination of two or more.

In addition, various examples of the present disclosure may be implemented in hardware, firmware, software, or a combination thereof. In the case of implementing the present disclosure by hardware, the present disclosure may be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A vehicle comprising:
a navigation system configured to provide a navigation map;
a processor; and
a memory storing at least one instruction that, when executed by the processor, is configured to cause the vehicle to:
determine that the vehicle has entered a junction indicated on the navigation map,
select, based on the determination, a final traveling route from among a plurality of routes that split at the junction, wherein the final traveling route is selected based on:
neighboring curvature radii respectively corresponding to the plurality of routes, and
a current curvature radius corresponding to a current lane on which the vehicle is traveling,
output a signal indicating the final traveling route, and
control, based on the signal, autonomous driving of the vehicle.

2. The vehicle of claim 1, wherein the at least one instruction, when executed by the processor, is configured to cause the vehicle to:
based on the determination that the vehicle has entered the junction, switch to a route correction mode,
determine the neighboring curvature radii respectively corresponding to the plurality of routes and determine the current curvature radius corresponding to the current lane,
determine, based on the neighboring curvature radii and the current curvature radius, a reliability associated with each of the plurality of routes, and
select, as the final traveling route, whichever route among the plurality of routes is associated with a highest reliability for guidance by the navigation system.

3. The vehicle of claim 2, wherein the at least one instruction, when executed by the processor, is configured to cause the vehicle to:
detect a lane line of the current lane,
generate, based on the lane line, lane line information,
determine, based on the navigation map, the neighboring curvature radii, and
determine, based on the lane line information, the current curvature radius.

4. The vehicle of claim 2, wherein the at least one instruction, when executed by the processor, is configured to cause the vehicle to:
determine a curvature radius difference between each of the neighboring curvature radii and the current curvature radius;
determine a shortest distance between each of the plurality of routes and a current position of the vehicle; and
based on the curvature radius difference and the shortest distance, determine the reliability associated with each of the plurality of routes.

5. The vehicle of claim 4, wherein the at least one instruction, when executed by the processor, is configured to cause the vehicle to, based on at least one of the shortest distances being equal to or greater than a preset threshold distance, end the route correction mode.

6. A vehicle comprising:
a navigation system configured to provide a navigation map;
a processor; and
a memory storing at least one instruction that, when executed by the processor, is configured to cause the vehicle to:
determine that the vehicle has entered a junction indicated on the navigation map,
select, based on the determination, a final traveling route from among a plurality of routes that split at the junction, wherein the final traveling route is selected based on:
a shape of each of the plurality of routes, and
a shape of a current lane on which the vehicle is traveling,
output a signal indicating the final traveling route, and
control, based on the signal, autonomous driving of the vehicle.

7. The vehicle of claim 6, wherein the at least one instruction, when executed by the processor, is configured to cause the vehicle to:
based on the determination that the vehicle has entered the junction, switch to a route correction mode,
determine neighboring regression polynomials representing respective shapes of the plurality of routes,
determine a current regression polynomial representing a shape of the current lane,
determine, based on the neighboring regression polynomials and the current regression polynomial, a reliability associated with each of the plurality of routes, and
select, as the final traveling route, whichever route among the plurality of routes is associated with a highest reliability for guidance by the navigation system.

8. The vehicle of claim 7, wherein the at least one instruction, when executed by the processor, is configured to cause the vehicle to:
detect a lane line of the current lane,
generate, based on the lane line, lane line information,
determine, based on the navigation map, the neighboring regression polynomials, and
determine, based on the lane line information, the current regression polynomial.

9. The vehicle of claim 7, wherein the at least one instruction, when executed by the processor, is configured to cause the vehicle to:
determine, for each of the plurality of routes, a difference between a neighboring regression polynomial representing the corresponding route and the current regression polynomial, and
determine, based on the difference, a reliability associated with each of the plurality of routes.

10. The vehicle of claim 9, wherein the at least one instruction, when executed by the processor, is configured to cause the vehicle to:
determine a shortest distance between each of the plurality of routes and a current position of the vehicle, and
based on at least one of the shortest distances being equal to or greater than a preset threshold distance, end the route correction mode.

11. A vehicle comprising:
a navigation system configured to provide a navigation map, wherein first geometric information representing a plurality of routes that split at a junction is obtained from the navigation map;
a sensor configured to detect lane lines of a current lane on which the vehicle is traveling and to provide second geometric information representing the current lane;
a processor; and
a memory storing at least one instruction that, when executed by the processor, is configured to cause the vehicle to:
determine that the vehicle has entered a junction indicated on the navigation map,
based on the determination, the first geometric information, and the second geometric information, select a final traveling route from among the plurality of routes,
output a signal indicating the final traveling route, and
control, based on the signal, autonomous driving of the vehicle.

12. The vehicle of claim 11, wherein the final traveling route is selected based on neighboring curvature radii respectively corresponding to the plurality of routes and a current curvature radius corresponding to the current lane.

13. The vehicle of claim 12, wherein the at least one instruction, when executed by the processor, is configured to cause the vehicle to:
determine, based on the neighboring curvature radii and the current curvature radius, a reliability associated with each of the plurality of routes, and
select, as the final traveling route, whichever route among the plurality of routes is associated with a highest reliability.

14. The vehicle of claim 12, wherein the at least one instruction, when executed by the processor, is configured to cause the vehicle to:
based on the determination that the vehicle has entered the junction, switch to a route correction mode,
determine a curvature radius difference between each of the neighboring curvature radii and the current curvature radius,
determine a shortest distance between each of the plurality of routes and a current position of the vehicle, and
based on the curvature radius difference and the shortest distance, determine a reliability associated with each of the plurality of routes.

15. The vehicle of claim 14, wherein the at least one instruction, when executed by the processor, is configured to cause the vehicle to, based on at least one of the shortest distances being equal to or greater than a preset threshold distance, end the route correction mode.

16. The vehicle of claim 11, wherein the final traveling route is selected based on shapes respectively corresponding to the plurality of routes and a shape corresponding to the current lane.

17. The vehicle of claim 16, wherein the at least one instruction, when executed by the processor, is configured to cause the vehicle to:
determine neighboring regression polynomials representing respective shapes of the plurality of routes,
determine a current regression polynomial representing a shape of the current lane,
determine, based on the neighboring regression polynomials and the current regression polynomial, a reliability associated with each of the plurality of routes, and
select, as the final traveling route, whichever route among the plurality of routes is associated with a highest reliability.

18. The vehicle of claim 17, wherein the at least one instruction, when executed by the processor, is configured to cause the vehicle to:
detect a lane line of the current lane,
generate, based on the lane line, lane line information,
determine, based on the navigation map, the neighboring regression polynomials, and
determine, based on the lane line information, the current regression polynomial.

19. The vehicle of claim 17, wherein the at least one instruction, when executed by the processor, is configured to cause the vehicle to:
based on the determination that the vehicle has entered the junction, switch to a route correction mode,
determine, for each of the plurality of routes, a difference between a neighboring regression polynomial representing the corresponding route and the current regression polynomial, and
determine, based on the difference, a reliability associated with each of the plurality of routes.

20. The vehicle of claim 19, wherein the at least one instruction, when executed by the processor, is configured to cause the vehicle to:
determine a shortest distance between each of the plurality of routes and a current position of the vehicle, and
based on at least one of the shortest distances being equal to or greater than a preset threshold distance, end the route correction mode.
